(19) United States
(12) Patent Application Publication
(10) Pub. No.: US 2005/0021768 A1
(43) Pub. Date: Jan. 27, 2005

(54) Interfacing of networks with different protocols via a media a gateway controller

(76) Inventor: Manfred Angermayr, Schrobenhausen (DE)

Correspondence Address: Siemens Corporation;Intellectual Property Departement, 170 Wood Avenue South, Iselin, NJ, 08830, US

(21) Appl. No.: 10/499,740

(22) PCT Filed: Dec. 12, 2002
(86) PCT No.: PCT/DE02/04562

(30) Foreign Application Priority Data
Dec. 20, 2001 (DE) 10162986.9

(51) Int. Cl. G06F 15/16

(52) U.S. Cl. 709/228

(57) ABSTRACT

Disclosed is a method for interfacing networks based on different protocols via a translator listing. The gateway of a first network is provided with an application comprising several processes, each of which scans the status information of a second network. In order to substantially reduce the time required to establish a connection and relieve the network, the status information scanned by one process is transferred to a common storage area which is accessible to all processes belonging to the same application and is located on the first gateway.

### CROSS REFERENCE TO RELATED APPLICATIONS

This application is the US National Stage of International Application No. PCT/DE02/04562, filed Dec. 12, 2002 and claims the benefit thereof. The International Application claims the benefits of German application No. 10162986.9 filed Dec. 20, 2001, both of the applications are incorporated by reference herein in their entirety.

### FIELD OF INVENTION

The present invention relates to a system and a method for connecting networks based on different protocols via a translation protocol in which the gateway of a first network is provided with an application comprising multiple processes, each of which queries the status information of a second.

### BACKGROUND OF INVENTION

The general background of the present invention is the transfer of signaling information in networks that consist for example of an IP network and a network based on the SS7 protocol, e.g. a PSTN.

The rapid introduction and flexible handling of different services, such as Unified Messaging in different networks calls for cross-network flow control. Cross-network control of services presupposes that the controllers of the IP networks can exchange signaling information with the switching nodes in the different networks (e.g. Public Switched Telephone Network PSTN, Intelligent Network IN, Public Land Mobile Network PLMN).

In a PSTN the signaling information and the user data are transferred separately from one another in two different networks, as shown in FIG. 2. The user data is forwarded to switching centers and the signaling data to signaling points. Transfer in the signaling network is handled via the SS7 protocol with the aid of MTP (SS7 Message Transfer Parts) and SCCP (Signal Connection Control Parts). The protocol architecture is shown in FIG. 3.

In contrast, transfer in an IP network takes place in Layer 3 in accordance with the OSI model.

For smooth cross-network transmission of the signaling information, it is therefore necessary to standardize the transmission methods for signaling information between the different networks on the basis of IP technology. The signaling information has to be converted at the network boundaries by signaling gateways (SG) to a common standard.

The signaling gateway must perform two functions, namely subscriber signaling and intermediate office signaling.

Subscriber signaling takes place between the controller and the subscriber devices or access components. The subscriber lines are physically combined either directly at the gateway or by means of access concentration and routed to the gateway in concentrated form. At the gateway the signaling information on the subscriber lines is filtered out and prepared for further transmission in the IP network.

For intermediate office signaling, additional requirements are made on the SG, particularly in the case of SS7. The signaling information is transferred independently of the user information as data packets in separate SS7 networks with the aid of the MTP (SS7 Message Transfer Parts) and the SCCP (Signal Connection Control Parts). The SS7 signaling gateway must be equipped with different network interfaces (ATM, IP) and handle different transport protocols (MTP, SCCP) in the direction of the IP network so that there is no need to reimplement unsuitable SS7 protocol stacks of the SS7 transport protocols in the controllers or servers of the IP network. Otherwise, the signaling information must be transported in the IP network without the service flow control of the network operating in sympathy. Different protocols such as the Stream Control Transmission Protocol (SCTP) have been developed for this. On this basis, user adaptation layers are implemented with the aid of which the higher signaling protocols (ISDN from PSTN, INAP from PLMN; MAP from IP) can be used without adaptation in the IP node. The user adaptation layers provide the interface between the different signaling protocols and the SCTP. For the SS7 signaling method the four user adaptation layers in the specification phase are as follows:
M2PA (MTP L2 user peer-to-peer adaptation layer),
M2UA (MTP L2 user adaptation layer),
M3UA (MTP L3-user adaptation layer) and
SUA (SCCP user adaptation layer).

M3UA emulates the interfaces of MTP L3 (SS7 Message Transfer Part L3) to the SS7 services, e.g. for the ISDN protocol ISUP. It also ensures that the signaling information is sent to the correct controller in the network and is delivered for the correct services.

In the M3UA protocol, an application is a logical unit that is responsible for call processing in a particular area. It usually consists of one or more processes. In accordance with the M3UA standard, all these processes operate independently of each other. This independence means that the signaling gateway has to inform each of these processes of the status of the SS7 network with the aid of SS7 Signaling Network Management (SSNM).

This includes messages such as DUNA (Destination Unavailable), DAVA (Destination Available) and SCON (SS7 Network Congestion).

In many architectures, all the processes of a particular application now run on a common host. Typically this is a media gateway controller (MGC). As all the SSNM information has to be transferred for each of the above processes, the load on the network is unnecessarily high.

### SUMMARY OF INVENTION

On the basis of the above state of the art, the object of the present invention is to reduce the time for connection setup and reduce the overall load on the network.

This object is achieved in accordance with the invention by the characteristics of the independent claims. The dependent claims form the central concept of the invention in a particularly advantageous way.

The central theme of the invention is that the status information queried by a process is transferred to a common storage area that can be accessed by all the processes associated with the application.

An example of such an application is a virtual database that processes all the HLR (Home Location Register) transactions for a particular connection in the networks.

It is advantageous to check in advance whether a storage area common to all the processes is available in which the status information can be placed. If not all the processes associated with an application run on one host then it is still of course necessary to transfer all the status information separately to each host on which processes are running.

The check as to whether such a common storage area is available can be configured statically in the signaling gateway. Depending on the application, the signaling gateway then decides whether it has to transfer the status information only once or separately for each process.

Another possibility, through a standard-compliant extension of the translation protocol, is to exchange the information as to whether a common storage area is available dynamically during connection setup. For this purpose, the protocol can send an additional character string in the message that initiates the connection between a process and a signaling gateway, in which it informs the signaling gateway that the status information is to be transferred either for only one process or for all the processes. In other words, a check is carried out to determine whether redundant status information is to be filtered.

In accordance with the translation protocol, the character string is an optional parameter that normally must not have unknown content. In the M3UA protocol, unknown content must only be transferred in the “InfoString” parameter, which is provided specifically for non-specified information.

This dynamic solution ensures that a signaling gateway that does not support the function simply ignores the character string and does not therefore produce errors in the protocol due to unknown commands. If, on the other hand, a signaling gateway does not receive the appropriate character string from a protocol, this indicates to the signaling gateway that the relevant application does not support this function and it has to send all the status information to each process of this application.

It is of no importance which process the signaling gateway sends the information to. To ensure homogeneous use of the hardware resources, the signaling gateway does not send all the status information to one process, but selects a different process as the addressee for each message.

The advantages and characteristics of the present invention are described below on the basis of an embodiment and with reference to the figures.

### BRIEF DESCRIPTION OF THE DRAWINGS

FIG. 1 shows a network.

FIG. 2 shows data transmission in a PSTN.

FIG. 3 shows the protocol architecture of SS7.

FIG. 4 shows the signal flow in an application.

### DETAILED DESCRIPTION OF INVENTION

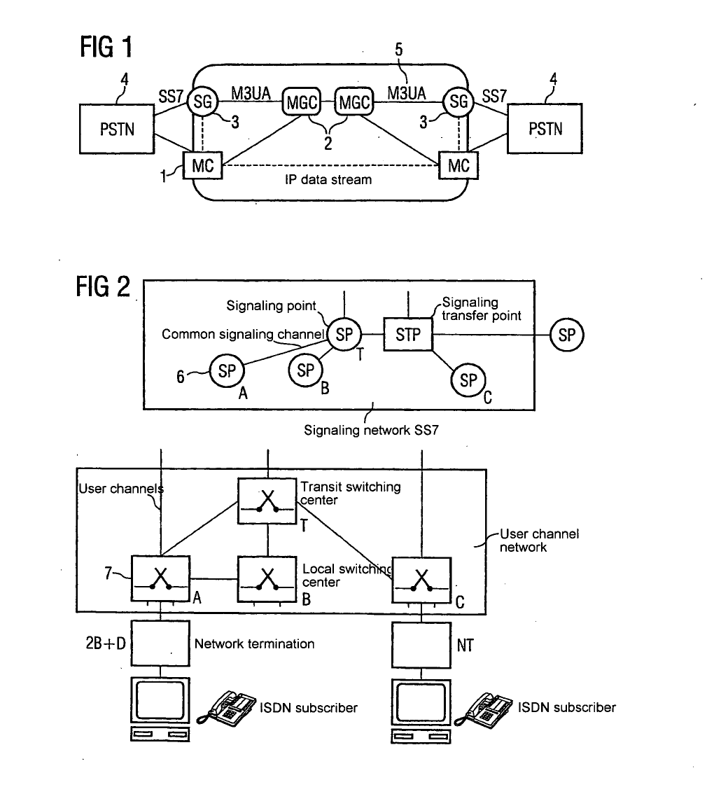

FIG. 1 shows an IP network to which a media gateway 1 and a media gateway controller 2 belong. This network is linked via a signaling gateway 3 with a PSTN (Public Switched Telephone Network) 4.

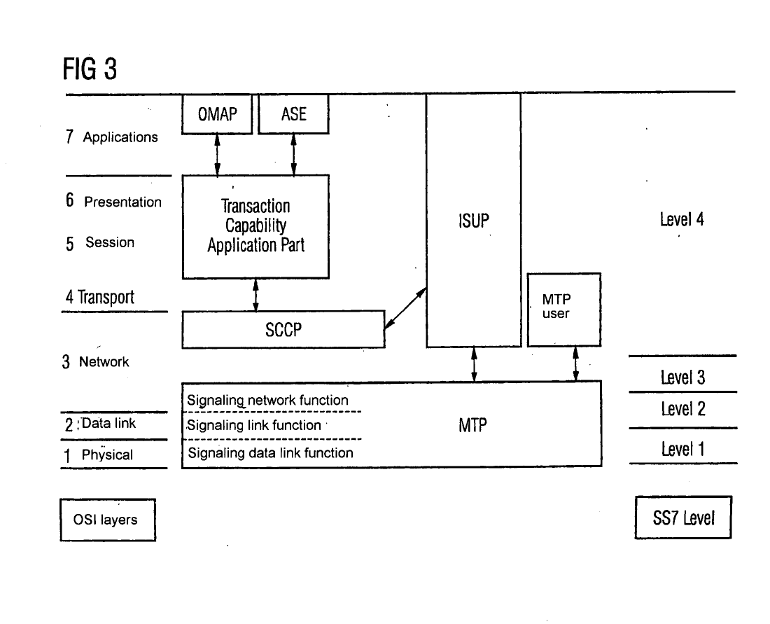

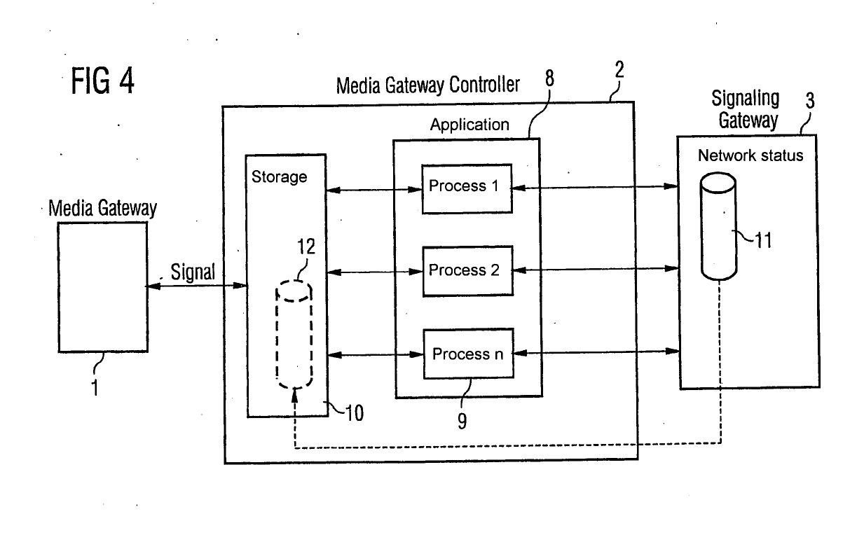

In a PSTN 4 the signaling information and the user data are transferred separately from one another in two different networks, as shown in FIG. 2. Transmission in the signaling network is handled via the SS7 protocol with the aid of the MTP (SS7 Message Transfer Parts) and the SCCP (Signal Connection Control Parts). The protocol architecture is shown in FIG. 3.

In contrast, transmission in an IP network takes place in layer 3 in accordance with the OSI model.

Different protocols have been developed for data transmission, such as the Stream Control Transmission Protocol (SCTP). On the basis of this, user adaptation layers are implemented with the aid of which the higher signaling protocols can be used without adaptation in the IP node. The user adaptation layers provide the interface between the different signaling protocols and the SCTP, whereby for example an M3UA (MTP Layer 3 user adaptation layer) exactly emulates the interface environment that the first ISDN protocol ISUP expects from an SS7 protocol.

The M3UA protocol 5 defines the communication between the signaling gateway 3 and the media gateway controller 2.

Typically, various applications 8 each comprising multiple processes 9 run on the media gateway controller 2. When a connection is set up, each of these processes 9 sends a message to signaling gateway 3. The signaling gateway 3 then sends information 11 on the status of the network to the processes.

The message from the process contains a “Redundant SSNM Filtering” character string as a parameter. The signaling gateway 3 must acknowledge the message. However, before it accepts an ACTIVE query from the process 9 it must, in accordance with the M3UA protocol 5, inform all the other processes of the application 8 about all the failed destinations in the SS7 network. Since the signaling gateway 3 knows from the “Redundant SSNM Filtering” character string, however, that all the processes 9 of this application 8 have a common storage area 10 for the SSNM information, it does not send this information 11 to all the processes but just to one 9. All the processes can access the information 12 held in the storage area 10. After transfer, the signaling gateway 3 can activate all the processes 9 by sending an ACTIVE confirmation.

16 processes can be connected to an SG, for example, via M3UA/STCP/IP for a particular application. If in this case there are 200 failed destinations to report, the signaling gateway 3 only has to transfer 1* 200=200 SSNM messages to the media gateway controller 2 before all the processes 8 are active. In accordance with the prior art, 16 * 200=3200 SSNM messages would have to be sent to the media gateway controller 2 before all the processes are active. The invention can therefore speed up connection setup considerably.

If an SS7 linkset fails on the signaling gateway 3, this can lead in extreme cases to a situation in which 2000 SS7 destinations fail. This information must now be reported to all the processes 9 with DUNA (Destination Unavailable).

By filtering the redundant SSNM messages it is sufficient however to send the information 11 to a single process. There is therefore no need to send 16 * 2000=32000 DUNAs, only 1 * 2000 messages need to be sent. The invention therefore reduces the load on the network significantly between the signaling gateway 3 and the media gateway controller 2.

1. A hand held unitary medical prescription transcriber and printer unit comprising:
structure of a size to be conveniently held in a user's hand, said structure including—
a voice responsive input device which converts the user's spoken word acoustic inputs into analog signals,
a converter operable to convert said analog signals into corresponding outputted digital signals,
a database of medical prescription information stored in digital format,
a formatting module operable to match only outputted digital signals from the converter with corresponding prescription digital data stored in the database to automatically format the matched digital signals into a form representative of a medical prescription, and
an integral printer operable to receive the formatted digital signals and to print out the formatted digital signals as readable hard copy directly from the unit.

2. A hand held medical transcriber and printer unit as set forth in claim 1, wherein said voice responsive device includes a microphone.

3. A hand held medical transcriber and printer unit as set forth in claim 1, wherein said voice responsive device is voice activated.

4. A hand held medical transcriber and printer unit as set forth in claim 1, wherein as provided an on off switch controlling operation of the voice responsive device.

5. A hand held medical transcriber and printer unit as set forth in claim 1, wherein is provided a storage element for the database information, said element being removably mounted in said structure for periodic updating of the database.

6. (Canceled)

7. A hand held medical transcriber and printer unit as set forth in claim 1, wherein is provided a programmable read-only memory module containing code segments coordinating operation of the voice responsive input device, the converter, the formatting module and the printer.

8. A hand held medical transcriber and printer unit as set forth in claim 1, wherein is included random access memory for temporary storage of the outputted digital signals and the formatted digital signals.

9. A hand held medical transcriber and printer unit as set forth in claim 1, wherein said printer is a thermal printer.

10. A hand held medical transcriber and printer unit as set forth in claim 1, wherein is included a recorder for recording each prescription which is transcribed and printed out by the unit permitting downloading thereof to a remote site and/or to provide a history of prescriptions written over a predetermined period of time.

11. A hand held medical transcriber and printer unit as set forth in claim 1, wherein is provided a display screen operable to display the formatted digital signals in readable word form prior to printing thereof.

12. A hand held medical transcriber and printer unit as set forth in claim 11, wherein is provided edit code segments permitting the user of the hand held unit to change the formatted digital signals after viewing the readout thereof on the display screen.

13. A hand held medical transcriber and printer unit as set forth in claim 11, wherein is provided alternate prescription information code segments operable to display a selection of prescription information on said screen different from but related to the formatted digital signals, and for permitting the user of the hand held unit to select different prescription information for delivery to the printer.

14. A hand held medical transcriber and printer unit as set forth in claim 1, wherein is provided an input connected to the database for selective modification of the database.

15. A hand held medical transcriber and printer unit as set forth in claim 1, wherein is provided code segments which generate an error message observable by the user of the unit in the event the formatting module is unable to match outputted digital signals from the converter with corresponding digital data stored in the database.

16. A process for preparing a printed copy of a medical prescription using a hand held transcriber and printer unit, said process comprising:
providing a voice responsive input device which converts the user's spoken word acoustic inputs into analog signals;
converting said analog signals into corresponding digital signals;
providing a database of medical prescription information stored in digital format;
matching only the digital signals with corresponding digital data stored in the database to automatically format the matched digital data into a form representative of a medical prescription; and
printing out a readable hard copy of the prescription information directly from the unit.

17. A process for preparing a printed copy of a medical prescription using a hand held transcriber and printer unit as set forth in claim 16, which includes the step of spectrally analyzing the digital signals by repetitively sampling thereof to facilitate matching of the spectrally analyzed digital signals with corresponding digital data in the database.

18. A process for preparing a printed copy of a medical prescription using a hand held transcriber and printer unit as set forth in claim 16, wherein is included the step of providing a voice activated acoustic input device.

19. A process for preparing a printed copy of a medical prescription using a hand held transcriber and printer unit as set forth in claim 16, wherein is included the step of periodically introducing additional digital data into the database to update the medical information database.

20. A process for preparing a printed copy of a medical prescription using a hand held transcriber and printer unit as set forth in claim 16, wherein is included the step of providing a display screen which is operable to display the prescription information in readable word form prior to printing thereof.

21. A process for preparing a printed copy of a medical prescription using a hand held transcriber and printer unit as set forth in claim 20, wherein is included the step of displaying the prescription information on the display screen to permit the user of the hand held transcriber and printer to edit the prescription information prior to printing of hard copy thereof.

22. A process for preparing a printed copy of a medical prescription using a hand held transcriber and printer unit as set forth in claim 20, wherein is included the step of providing a display of alternate medical information on the display screen, and permitting the user to select particular medical information from that displayed on the display screen.

23. A process for preparing a printed copy of a medical prescription using a hand held transcriber and printer unit as set forth in claim 20, wherein is provided the step of displaying an error message on the display screen in the event a match is not made between the digital signals and the prescription information digital data stored in the database.

24. A process for preparing a printed copy of a medical prescription using a hand held transcriber and printer unit as set forth in claim 16, wherein is provided the step of recording a history of prescriptions transcribed and printed by the unit for periodic review and recordkeeping purposes.

25. A process for preparing a printed copy of a medical prescription using a hand held transcriber and printer unit as set forth in claim 16, wherein is provided the step of transferring the recorded history of prescriptions transcribed and printed by the unit to a remote storage site.

26. A hand held unitary medical prescription transcriber and printer unit comprising:
a voice responsive input device which coverts a user's spoken word acoustic inputs into analog signals;
a converter operable to convert the analog signals into corresponding outputted digital signals;
a formatting module operable to automatically format the outputted digital signals into a form representative of a prescription by searching the outputted digital signals to identify prescription information; and
an integral printer operable to print out the formatted digital signals as readable hard copy directly from the unit.

27. The handheld medical transcriber as set forth in claim 26, wherein the prescription information includes a prescription name, a prescription dosage, and a prescription duration.

28. The handheld medical transcriber as set forth in claim 26, wherein the unit includes a database of medical prescription information stored in digital format.

29. The handheld medical transcriber as set forth in claim 28, wherein the formatting module identifies the prescription information by matching the outputted digital signals with the medical prescription information stored in the database.

30. The handheld medical transcriber as set forth in claim 28, wherein the formatting module searches the database of medical prescription information for information associated with the formatted digital signals.
